(19) United States
(12) Patent Application Publication
(10) Pub. No.: US 2022/0383296 A1
(43) Pub. Date: Dec. 1, 2022

(54) Novel Security Relational Distributed Ledger Data Base Management System using Blockchain Security, with digital Wallets. Tokens and Non Fungible Tokens in an Evidence Chain of Custody (Ecoin or Veritas Token) and Validation process for an unique and novel "Proof Of Truth" protocol.

(71) Applicant: Karla Gottschalk, Ocean View, HI (US)

(72) Inventor: Karla Gottschalk, Ocean View, HI (US)

(21) Appl. No.: 17/588,700

(22) Filed: Jan. 31, 2022

Related U.S. Application Data
(60) Provisional application No. 63/195,047, filed on May 30, 2021.

(51) Int. Cl. G06Q 20/36; G06Q 50/18

(52) U.S. Cl. CPC G06Q 20/3672; G06Q 50/18; G06Q 2220/00

(57) ABSTRACT

NFTs are part of a new decentralized financial system or rather asset securitization. Even the minting of perpetual domain names by creating them as blockchain entities (ie, e-chain.nft for evidence chain domain under International-Judicial-Council.DAO (decentralized autonomous organization) rather than private individuals running public private government contracts.

Different Judicial Districts could set up their own mining (act of putting blocks on blockchain) rig to insulate the ECC (evidence custody coin) NFT from outside interference and becoming an independent blockchain node. This is very affordable from DIY to FullNode, plug and play, with many options.

Even in probate courts, and other similar venues, it is possible to create case specific wallets, including, not limited to Special Needs Wallets.

In writing this patent I realized that immutable boot up genesis blocks for robotics and artificial intelligence and sensor array monitoring based on immutable positioning and adjustments in space travel and celestial navigation are already within reach of this unique and novel protocol.

Coding is open source, ERC-20, -721, 1155 and combined as developed to create a chain of custody for all “Proof of Truth” evidence or potential evidence with infinite descriptor fields, audio visual, digital double on an immutable and transparent blockchain ledger.

The combined elements of wallet, node and non-fungible tokens allow for this needed check on fraud and corruption.

A) Law and Government

Evidence chain of custody for all transactions in Law: Judicial, executive or legislative including all legal fictions and entities tied to immutable verification.

Programming and advertising propaganda and claims.

Barter, ticketing, expertising and anti-counterfeiting

(B) Food and Medicine

Medical, pharmaceutical and food tracking and testing and certification

(C) Artificial Intelligence, Robots and Exploration

Time clock functions for critical validation and validated updates.

Artificial Intelligence limits (breakpoint) for critical data, boot loaders and possible responses to assure compliance with programmed verifiable limits to behavioral automation, data integrity over time and record of changes that are immutable and transparent.

Cartography, maps and navigation

Monitoring sensor arrays in electromagnetic propulsion and guidance.

The Evidence NFT combined with in place tokenization and wallet storage options, is non-obvious to the average or even above-average person competent in crypto currencies and NFTs as the judicial system is not usually contemplated as being affected by the Blockchain. The combination is not a readily predictable result of the blockchain Revolution.

Evidence will be securitized as well as so many other processes having to do with legal subjects and practice as well as all other similar situations needing securitization of real-world goods, services and

### BACKGROUND OF THE INVENTION

For many years since the beginning of the blockchain the Inventor has been looking for a way to use the transparency and immutability of the blockchain to evidence, including, but not limited to evidence lockers, in the judicial system.

The invention is the unique process of combining, in the alternative and in combination with blockchain protocols, the various elements with the Non Fungible token.

With Non-Fungible Tokens (NFTs) it is possible to add to the blockchain real items unique unto themselves. The immediate application is for preservation of evidence and has not been thought of before.

The major characteristic of NFTs are immutability and transparency which insures security as it does for the commercial tokens like Bitcoin.

A Non-Fungible Token (NFT) is not money like Bitcoin (BTC), Etherium (ETH) or alternate coins that do some purposeful activity from fun to serious blockchain improvements. They all use a computer, the internet, exchanges and now with a fungible digital asset representing any and all material items and new digital productions that need to be preserved intact with provenance tracking of all users and transfers in a verifiable and immutable, as well as transparent, format.

NFTs share in blockchain technology but the non-obvious use for real world “proof of truth” is only now being here explored, for example, in an Evidence Chain of Custody (ECC or Validity “coin”) requirements for civil and criminal justice systems of whatever kind and wherever situated. It can be adjusted for a myriad of real world legal documentation and even private legal entity additions to the blockchain through available Decentralized Finance (DeFi) apps and protocols, especially ERC-721. Etherium Record of Change (ERC) is what allows for the NFT to be added as a block in the chain. Etherium is the current cost of building the original block or subsequent transfers and is a “gas” fee but there are current contenders trying to make the “gas” less costly in Chainlink (LINK), Solana (SOL) and Polygon (MATIC) to name just a few.

L2 (Layer 2 or Web3) deployments to taproot upgrades of BTC allows for side chains and more ways to deploy contracts. These side chains and “proof of work” (BTC) and ETH to “proof of stake” in DeFi Applications to reduce transaction fees (in ETH) are also known as mining fees.

The novelty is apparent as an Evidence Chain of Custody model has not been described in print, in public use or for sale.

“Miners” are a group of people who set up computers to run a peer-to-peer decentralized cloud that is the blockchain. The blockchain has used “proof of work” (the proof is mathematical work) and the newer decentralized apps and uses “proof of stake” (proof that you have the underlying asset that is staked or pledged to a project of the decentralized application or DAO, distributed autonomous organization) much like other legal associations throughout society but with increased security and transparency. Each unit of a command structure could be independent, transparent and free.

These secure decentralized transparent and immutable data blocks are also for application related to NASA and DARPA projects that exist but unrealized and not immediately obvious until “Proof of Truth” protocols are used in AI, space travel and exploration.

Very few programmers are lawyers so there is no “Proof of Truth” of material items and digital files previously known in the art. The Veritas e-coin is based on a top down vision solving an important problem moving the current art of digital creations to the “Proof of Truth” in governments, it's organs and licensees, corporations and in essence all data blocks used for real world needs in “proof of Truth” verifications.

### SUMMARY OF THE INVENTION

The Evidence Chain of Custody NFT and Token combination will guarantee the immutability of evidence in, for example, police departments. The protocol above allows for unlimited descriptors per each unique item, including pictures (audio and visual means), digital or other to accompany the logged in evidence. Once on the blockchain through the decentralized ledger environment security is guaranteed. If the original degrades or something causes destruction of the original or it is destroyed a certifiably correct digital mirror is kept in perpetuity.

Transferability, between officers, courts or other departments, allows for wallet ID verification and officer log in with a unique personal and public key while maintaining an immutable and transparent chain of custody stack.

Each Evidence Chain of Custody (ECC) NFT and Token combo will have unique addresses and allow for recordation and tracking of the items voyage through different “hands”. Each administrator of the evidence log will have their wallet and unique identifier for access to the evidence and transfer to a requesting party and track return to final disposition.

Each party in the chain will be the owner of the evidence until returned which should prevent loss, tampering or changing evidence because the unique identifier will be attached to both the object and the person in custody of it.

A by-product of this approach is the data relating to how many times it is accessed and by whom and compared with what other evidence is valuable data to have in forming batch access privileges.

Bitcoin (BTC) uses ERC-20 protocol which is the basis of the smart contracts and other tokens are also smart contracts stored on the BTC protocol. ERC-1155 adds multi token ability and additional functions related to descriptors of evidence and kind in an unlimited manner.

The NFT ERC's will continue to evolve to meet the needs of digital non fungible tokens in various real world situations. Just the data in any navigational digital connection will allow new celestial advances and logging for explorations by humanity or its machines.

The Evidence Chain of Custody (ECC) NFT is not limited to the Justice system but the use of NFTs and blockchain decentralization and protocols to secure unique tangible items of any sort, including, but not limited to digital forensic evidence.

Digital assets are stored in wallets. There are digital wallets where someone can store digital tokens the same way they use a leather wallet. These tokens in the digital world need a place or digital wallet to hold them. These wallets can be developed personally or by using a well known soft online wallet.

Hard wallets (secure offline storage) are preferred for security reasons and will be the preferred choice for the NFT and the soft wallet (online storage) for individual users to study or access the evidence or other unique item.

Metamask is an example of digital wallets to store tokens. These are software Applications (Apps) someone can install for free on their Personal Computer (PC), laptop or mobile devices like smartphone or tablet as long as these devices are connected to the internet. Metamask allows storage of NFTs. There are others in the growing digital world but not “proof of truth” ledgers that are transparent and immutable.

1. This overall novel use and combinations of the blockchain and current protocols to a real world need for legitimacy and security with NFTs using open-source programming is adaptable to many unique real world situations requiring immutable and transparent verifiable storage, chain of custody, ownership, bookkeeping, Government contracts, proceedings or any chain of events and things. This includes judicial, legislative and executive branches of governments and thier extensions through legal fictions and other entities.
Primarily, this I believe is covered under Internet of Things G16Y cooperative patents classes. The primary Class 717,705/706 and subclasses for networking, linking, breakpoints, a component based invention that is distributed through the World Wide Web using the blockchain contracts.
This is an entirely novel way to developing cryptographic distributed ledger security. It could be used for tracking:
(1) medical and pharmaceutical trial and drug manufacturing (Law, gov or other regulatory)
(2) food certifications, and tracking of indicators during use and following deployment (Law, gov or other regulatory)
(3) Voting and vital statistics Demographics (Law, gov or other regulatory)
(4) Evidence of Educational and other certifications (Law, gov or other regulatory)
(5) time clock functions for valuation (NASA and DARPA) (Law, gov or other regulatory)
(6) robotic and AI Limit Immutabilities to set basic immutable parameters for sensors and celestial navigation and electromagnetic or other propulsion maintenance (NASA and DARPA)
(7) Cartography and Celestial Navigation—Maps, (NASA and DARPA)
(8) Monitoring sensor array synchronization in electro-magnetic propulsion systems and for gyroscopic positioning integrity with ferrofluids and magnetorheological liquids together or separately. (NASA and DARPA)
(9) accounting for assets and other financial instruments in banks and exchanges, verification of barter and anti-counterfeiting (LAW)(gov or other regulatory)
(10) real estate deed descriptors and chain of ownership and progress progress payments (LAW)(gov or other regulatory)
(11) expertising of collectibles (Private associations)
(12) purchasing and selling of modes of transportation (LAW)(gov or other regulatory)
(13) insurance and other warranties using serial numbers ((LAW)gov or other regulatory)
(14) notarized documents, wills, trusts, codicils ((LAW)gov or other regulatory)
(15) and other chain of ownership of or by legal fictions including corporate updates to bylaws and rights, etc., (LAW)(gov or other regulatory) and
(16) all governmental legislative, administrative, executive, including military and police powers, or judicial records including all legal fictions. (LAW)
